(19) United States
(12) Patent Application Publication
(10) Pub. No.: US 2013/0098659 A1
(43) Pub. Date: Apr. 25, 2013

(54) PRE-PLATED LEAD FRAME FOR COPPER WIRE BONDING

(71) Applicants: Yiu Fai KWAN, Hong Kong (HK); Ching Man TSUI, Kwai Chung (HK); Say Teow CHAN, Singapore (SG); Yu Lung LAM, Kwai Chung (HK); Tat Chi CHAN, Shatin (HK)

(72) Inventors: Yiu Fai KWAN, Hong Kong (HK); Ching Man TSUI, Kwai Chung (HK); Say Teow CHAN, Singapore (SG); Yu Lung LAM, Kwai Chung (HK); Tat Chi CHAN, Shatin (HK)

(21) Appl. No.: 13/658,472

(22) Filed: Oct. 23, 2012

Related U.S. Application Data
(60) Provisional application No. 61/550,992, filed on Oct. 25, 2011.

(51) Int. Cl. H01B 5/00; B05D 5/12

(52) U.S. Cl. 174/126.2; 427/125

(57) ABSTRACT

A pre-plated lead frame comprises a substrate comprising copper or a copper alloy which has a first side and a second side opposite to the first side. A first plating layer comprising nickel is plated on the first and second sides of the substrate and a second plating layer comprising palladium is plated onto the first plating layer on the first and second sides of the substrate. A third plating layer comprising gold is then plated onto the second plating layer on the second side of the substrate, the third plating layer on the second side of the substrate having a thickness of more than 3 nm. On the first side of the substrate, there is either no gold plated onto the second plating layer, or a third plating layer comprising gold plated onto the second plating layer which has a thickness of 1.5 nm or less.

### FIELD OF THE INVENTION

The invention relates to lead frames used for assembling semiconductor packages, and in particular, lead frames that are adapted especially but not exclusively for copper wire bonding.

### BACKGROUND AND PRIOR ART

During the production of semiconductor devices, lead frames are traditionally used as a cost-effective way to mount and process a plurality of semiconductor dice or chips concurrently. Each lead frame typically has a plurality of die pads for mounting the said chips. The lead frame also acts as a means to electrically connect the semiconductor chip to external devices via leads of the lead frame. Bonding wires are connected to electrical contacts found on the semiconductor chip and said leads of the lead frame in a process known as wire bonding. The wires usually comprise gold, aluminum or copper material.

After the semiconductor chips have been mounted onto the lead frame and the bonding wire connections have been made between the semiconductor chips and the lead frame, each semiconductor chip has to be protected from the environment by encapsulating it with a plastic molding compound, such as epoxy molding compound (“EMC”). Each encapsulated chip constitutes a semiconductor package. The multiple semiconductor packages are then diced or singulated to form individual semiconductor devices.

Gold wire has been used for a long time in semiconductor assembly as an electrical interconnection between a semiconductor chip and a lead frame. Due to the ever-increasing price of gold, there has been a move towards the use of copper wire as a low-cost alternative to gold wire. Moreover, copper wire has higher electrical conductivity as compared to gold wire. However, copper wire suffers from several shortcomings. It is harder than gold and oxidization of copper takes place very easily when it is exposed to the atmosphere. Its rate of oxidation further increases when it is heated during wire bonding. These factors make the copper wire bonding process window much narrower as compared to gold wire bonding.

Presently, 3-layer and 4-layer plating schemes for pre-plated lead frames are common in the industry. Such plating schemes are described for instance in U.S. Pat. No. 7,408,248 entitled, “Lead Frame for Semiconductor Device”. The 3-layer plating scheme may consist of nickel, palladium and gold layers, whereas the 4-layer plating scheme may consist of nickel, palladium, gold and silver layers.

FIG. 1 is a cross-sectional view of a conventional pre-plated lead frame 100 with three plating layers. It consists of a base metal 102 made of a copper alloy, a nickel layer 104 on top of the base metal 102, a palladium layer 106 on top of the nickel layer 104, and a gold layer 108 on top of the palladium layer 106. These multiple layers are uniformly plated on both the top and bottom sides of the conventional pre-plated lead frame 100. In particular, the gold layer 108 is plated to a thickness of more than 3 nm (30 angstroms).

A problem that has been faced with the aforementioned conventional 3-layer and even 4-layer plating schemes is that they have a high surface hardness arising from the thick gold layer. When copper bonding wire, which is relatively hard, is bonded onto a hard lead frame surface, there is poor surface contact such that wire bonding becomes more difficult to perform. Moreover, micro-gaps may appear between the interface between the copper wire and pre-plated lead frame, which decreases the strength of the bond. Furthermore, one function of the multiple plating layers is to create a barrier layer to prevent diffusion of copper and/or nickel atoms to the lead frame surface, whereat oxidation at the surface of the lead frame may result. Oxidation at the surface of the lead frame adversely affects wire bonding quality. It has been found that the 3-layer pre-plated lead frame in particular is not very successful in preventing the diffusion of copper and nickel atoms to the lead frame surface.

### SUMMARY OF THE INVENTION

It is thus an object of the invention to seek to formulate a plating scheme for a pre-plated lead frame that is especially suitable for copper wire bonding so as to avoid some of the shortcomings faced by conventional pre-plated lead frames during copper wire bonding.

According to a first aspect of the invention, there is provided a pre-plated lead frame comprising: a substrate comprising copper or a copper alloy which has a first side and a second side opposite to the first side; a first plating layer comprising nickel plated on the first and second sides of the substrate; a second plating layer comprising palladium plated onto the first plating layer on the first and second sides of the substrate; and a third plating layer comprising gold plated onto the second plating layer on the second side of the substrate, the third plating layer on the second side of the substrate having a thickness of more than 3 nm; wherein either the first side of the substrate has no gold plated onto the second plating layer, or comprises a third plating layer comprising gold plated onto the second plating layer which has a thickness of 1.5 nm or less.

According to a second aspect of the invention, there is provided a method of manufacturing a lead frame, comprising the steps of: providing a substrate comprising copper or a copper alloy which has a first side and a second side opposite to the first side; plating nickel onto the first and second sides of the substrate to form a first plating layer; plating palladium onto the first plating layer on the first and second sides of the substrate to form a second plating layer; plating gold onto the second plating layer on the second side of the substrate to form a third plating layer, the third plating layer on the second side of the substrate having a thickness of more than 3 nm; and either plating gold onto the second plating layer on the first side of the substrate to form a third plating layer having a thickness of 1.5 nm or less, or not plating gold onto the second plating layer on the first side of the substrate.

It will be convenient to hereinafter describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

An example of a pre-plated lead frame according to the preferred embodiment of the invention will now be described with reference to the accompanying drawings, in which:

FIG. 1 is a cross-sectional view of a conventional pre-plated lead frame with three plating layers;

FIG. 2 is a cross-sectional view of a pre-plated lead frame according to the preferred embodiment of the invention; and

FIGS. 3(a) and 3(b) are schematic views of grain surface morphologies of a conventional smooth lead frame surface and a roughened lead frame surface according to the preferred embodiment of the invention respectively.

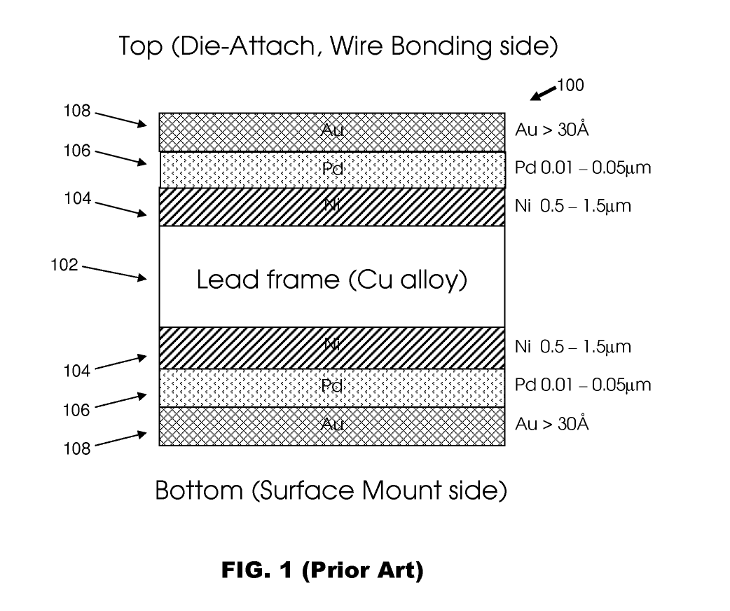

### DETAILED DESCRIPTION OF THE PREFERRED EMBODIMENT OF THE INVENTION

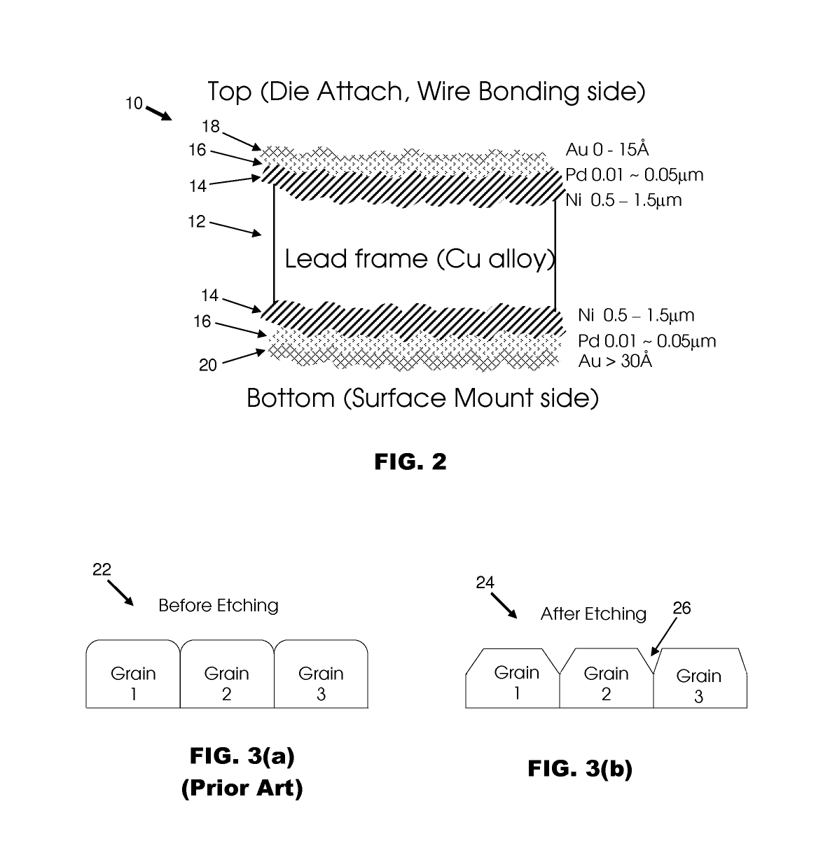

FIG. 2 is a cross-sectional view of a pre-plated lead frame 10 according to the preferred embodiment of the invention. The pre-plated lead frame 10 has a substrate comprising a base metal 12 which may comprise copper or a copper alloy. A first layer of nickel 14 is plated throughout the base metal 12 to a thickness of 0.5 μm to 1.5 μm. A second layer of palladium 16 is plated on top of the layer of nickel 14 throughout the lead frame 10 to a thickness of 0.01 μm to 0.05 μm.

To overcome the bonding problems faced with conventional pre-plated lead frames 100 as described above, the pre-plated lead frame 10 in accordance with the invention differentiates between a first side of the lead frame 10 where die-attach and wire-bonding is to be performed, and a second side of the lead frame 10 opposite to the first side by which the packaged device is to be mounted onto other components and devices. Die-attach refers to the mounting of semiconductor chips or dice to the lead frame 10 and this is generally on the same side as where wire-bonding is performed. In this case, wire bonding is expected to be carried out using copper wire. The second side of the lead frame 10 is the surface mount side of the lead frame 10 which is generally attached to other devices or components using solder. The first and second plating layers 14, 16 are plated onto both the first and second sides of the lead frame 10.

The die-attach or wire-bonding side of the lead frame 10 is generally its top side (or the first side as described above). In order to overcome the bonding problems as seen in the prior art, the top side of the lead frame 10 should have only a thin layer of gold plating of up to 1.5 nm (15 angstroms), or may contain no gold at all. The said reduction or elimination of the gold layer is found to reduce the surface hardness of the lead frame 10 and to promote its suitability for copper wire bonding.

On the other hand, the bottom side (or the second side as described above) opposite to the top side may be plated with a thicker layer of gold, of more than 3 nm (30 angstroms). The above construction of the plating layers enables the pre-plated lead frame 10 to be especially suitable for copper wire bonding on its top side, as well as continue to be suitable for being surface-mounted on its bottom side to other devices or components.

Another advantage of the pre-plated lead frame 10 according to the preferred embodiment of the invention is that it is found to inhibit diffusion of copper and nickel atoms to the surface of the lead frame 10.

Conventionally, the nickel layer 14 acts as the diffusion barrier to prevent the migration of the underlying copper atoms of the base metal 12 made of copper alloy to the top surface of the lead frame 10. In turn, the palladium layer 16 acts as a diffusion barrier to prevent nickel atoms from migrating to the top surface of the lead frame 10. As the palladium layer 16 is thin, the purity of the palladium layer 16 and the plating quality is vital for this function because the nickel atoms beneath it will migrate to the top surface if there are defects in the palladium layer 16.

It has been found by the inventors herein that diffusion or the atomic exchange rate of nickel towards gold is much faster than it is towards palladium. Hence, any nickel that has diffused to the palladium layer 16 will readily diffuse to the top-most gold layer, and a thicker gold layer 18 will attract more nickel atoms from beneath the palladium layer 16. As such, with a thicker gold layer 18, nickel atoms inside the gold layer 18 will diffuse more readily to the top surface of the lead frame 10 to form nickel oxide in its most stable form, such that the surface energy will be minimized. Nickel oxide on the top surface of the lead frame 10 will lead to degradation of the bondability of the lead frame 10. As such, minimization of the thickness of the gold layer 18 serves to inhibit oxidation occurring at the surface of the lead frame 10 and will be beneficial to copper wire bonding.

FIGS. 3(a) and 3(b) are schematic views of grain surface morphologies of a conventional smooth lead frame surface 22 and a roughened lead frame surface 24 according to the preferred embodiment of the invention respectively. In a conventional smooth lead frame surface 22 schematically illustrated in FIG. 3(a), grains on the lead frame surface are quite regular. As a result, they would form a relatively hard surface which may inhibit bonding of copper wire to it, since copper is also a relatively hard material.

On the other hand, in a roughened lead frame surface 24 schematically illustrated in FIG. 3(b), the grains do not have such a regular contour. A roughening process such as etching will tend to cause preferential etching at the grain boundaries between adjacent grains. As a result, larger gaps 26 are created between adjacent grains. Thus, there are more apices for intimate contact between the grains and the copper bonding wire.

The etched surface looks like the whole surface has been divided into multiple isolated islands. As a consequence, the top surface can be freely moved or deformed during the pressing or scrubbing action of a capillary used for wire bonding. Individual grains can be deformed without the constraints typically exerted by their neighboring grains. It has been found that this feature facilitates bonding the relatively hard copper wire to the etched surface of the lead frame 10.

Generally, surfaces on the copper alloy base metal 12 will be roughened before plating the respective plating layers 14, 16, 18, 20 onto it. Roughening can be performed at a separate etching station, or at the plating station just before plating. Roughening may be achieved through etching by way of a chemical reaction between the copper alloy and oxidizing agents. Examples of suitable etchant chemicals are potassium, sodium or ammonium salt of a persulfate or peroxide, nitric acid or ferric chloride. During such etching process, the base metal 12 may be immersed in the chosen chemical for 5 to 60 seconds with the temperature controlled at between 15° C. and 35° C.

It should be appreciated that the pre-plated lead frame 10 according to the preferred embodiment of the invention facilitates enhanced bondability for copper wire as compared to conventional lead frames 100. Furthermore, since little or no gold is used on the top surface of the lead frame 10, the pre-plated lead frame 10 can be manufactured with lower cost, especially in an environment where gold prices are ever-increasing.

The invention described herein is susceptible to variations, modifications and/or additions other than those specifically described and it is to be understood that the invention includes all such variations, modifications and/or additions which fall within the spirit and scope of the above description.

1. A pre-plated lead frame comprising:
a substrate comprising copper or a copper alloy which has a first side and a second side opposite to the first side;
a first plating layer comprising nickel plated on the first and second sides of the substrate;
a second plating layer comprising palladium plated onto the first plating layer on the first and second sides of the substrate; and
a third plating layer comprising gold plated onto the second plating layer on the second side of the substrate, the third plating layer on the second side of the substrate having a thickness of more than 3 nm;
wherein either the first side of the substrate has no gold plated onto the second plating layer, or comprises a third plating layer comprising gold plated onto the second plating layer which has a thickness of 1.5 nm or less.

2. The pre-plated lead frame as claimed in claim 1, wherein a thickness of the first plating layer comprising nickel is 0.5 μm to 1.5 μm.

3. The pre-plated lead frame as claimed in claim 1, wherein a thickness of the second plating layer comprising palladium is 0.01 μm to 0.05 μm.

4. The pre-plated lead frame as claimed in claim 1, wherein the first side of the substrate is configured for performing die attach and/or wire bonding on the substrate, and the second side of the substrate is a surface mounting side configured for mounting a packaged device manufactured from the substrate onto other components and devices.

5. The pre-plated lead frame as claimed in claim 1, wherein surfaces on the first and second sides of the substrate have been roughened by etching the substrate using an oxidizing agent to cause preferential etching at grain boundaries on the surfaces to create larger gaps between adjacent grains before formation of the respective plating layers.

6. A method of manufacturing a lead frame, comprising the steps of:
providing a substrate comprising copper or a copper alloy which has a first side and a second side opposite to the first side;
plating nickel onto the first and second sides of the substrate to form a first plating layer;
plating palladium onto the first plating layer on the first and second sides of the substrate to form a second plating layer;
plating gold onto the second plating layer on the second side of the substrate to form a third plating layer, the third plating layer on the second side of the substrate having a thickness of more than 3 nm; and
either plating gold onto the second plating layer on the first side of the substrate to form a third plating layer having a thickness of 1.5 nm or less, or not plating gold onto the second plating layer on the first side of the substrate.

7. The method of manufacturing a lead frame as claimed in claim 6, wherein a thickness of the first plating layer comprising nickel is 0.5 μm to 1.5 μm.

8. The method of manufacturing a lead frame as claimed in claim 6, wherein a thickness of the second plating layer comprising palladium is 0.01 μm to 0.05 μm.

9. The method of manufacturing a lead frame as claimed in claim 6, wherein the first side of the substrate is configured for performing die attach and/or wire bonding on the substrate, and the second side of the substrate is a surface mounting side configured for mounting a packaged device manufactured from the substrate onto other components and devices.

10. The method of manufacturing a lead frame as claimed in claim 6, further comprising the step of, prior to plating nickel onto the first and second sides of the substrate, roughening surfaces on the first and second sides of the substrate by etching the substrate using an oxidizing agent.

11. The method of manufacturing a lead frame as claimed in claim 10, wherein the etching process comprises the steps of immersing the substrate in the oxidizing agent for 5 to 60 seconds at a temperature controlled at between 15° C. and 35° C.

12. The method of manufacturing a lead frame as claimed in claim 10, wherein the oxidizing agent is selected from the group consisting of: potassium, sodium or ammonium salt of a persulfate or peroxide, nitric acid and ferric chloride.
